(19) United States
(12) Patent Application Publication
(10) Pub. No.: US 2016/0317933 A1
(43) Pub. Date: Nov. 3, 2016

(54) AUTOMATIC GAME SUPPORT CONTENT GENERATION AND RETRIEVAL

(71) Applicant: Lucidlogix Technologies Ltd., Natanya (IL)

(72) Inventor: Yoel Shoshan, Haifa (IL)

(21) Appl. No.: 14/701,554

(22) Filed: May 1, 2015

(51) Int. Cl. A63F 13/77

(52) U.S. Cl. CPC A63F 13/77

(57) ABSTRACT

A system for improving the playing of video gaming sessions includes one or more gamer computer systems and associated one or more gamers; one or more servers, the one or more servers having an associated storage for storing one or more video or audio/video clips and associated metadata corresponding to one or more portions of a video game; the one or more servers are enabled to receive one or more requests from the one or gamers of the one or more gamer computers for a selected portion of a video game; upon receipt of one or more requests from the one or more gamer computer systems, the server searches, using the associated metadata, the associated storage to determine whether the selected portion is available, and, if available, transmits the selected portion of the video game to the one or more gamer computer systems.

### FIELD OF THE INVENTION

The present invention relates generally to the field of video games. More specifically, the present invention relates to automatic game support content generation and retrieval.

### BACKGROUND

Computer and video gaming are becoming more and more popular. Some gamers spend a notable part of their leisure time playing or learning about games, In the United States, the average video game player is 30 years old and has been playing video games for over 12 years. There are several types of gamers: A casual gamer is a player whose time or interest in playing games is limited. Casual gamers may play games designed for ease of gameplay, or play more involved games in small groupings of time, at a slower pace than hardcore gamers. The core or mid-core gamer is a player with a wider range of interests than a casual gamer and is more likely to enthusiastically play different types of games, but without the amount of time spent and sense of competition of a hardcore gamer. Hardcore gamers spend a good amount of their time playing video games, often have the latest consoles/high-end PCs, and are usually technologically savvy. In addition, they prefer to play games that have depth and complexity and often seek out game-related information. Professional gamers play video games and deeply study the game to master it and usually to play in competitions. Professional gamers don't necessarily play for money or earn a salary, but many do. “Newbie,” or “Noob,” is a slang term for a novice or newcomer to a certain game, or to gaming in general. Computer or video games are becoming increasingly challenging, and gamers are spending much of their time struggling to overcome these challenges. Often, gamers need to repeat a certain level of the game over and over again in order to be able to progress to the next level. There are many gamer communities and forums on the Internet in which general gaming issues, suggestions, techniques, etc. are discussed, as well as discussions about the techniques of overcoming game obstacles in a particular level of a particular game.

### SUMMARY OF THE INVENTION

In an aspect, a system for improving the playing of video gaming sessions includes one or more gamer computer systems and associated one or more gamers; one or more servers, the one or more servers having an associated storage for storing one or more video or audio/video clips and associated metadata corresponding to one or more portions of a video game; the one or more servers are enabled to receive one or more requests from the one or gamers of the one or more gamer computers for a selected portion of a video game; upon receipt of one or more requests from the one or more gamer computer systems, the server searches, using the associated metadata, the associated storage to determine whether the selected portion is available, and, if available, transmits the selected portion of the video game to the one or more gamer computer systems.

In a second aspect, one or more gameplay publisher computer systems are enabled to send the one or more video or audio/video clips and associated metadata extracted from the one or more video or audio/video clips to the associated storage of the one or more servers for storage.

In another aspect, the server indexes the stored video clips based, at least in part, on the associated metadata extracted from the one or more video or video/audio clips.

In a further aspect, the one or more gameplay publisher computer systems performs one or more of: frame capture of graphics frames generated by the one or more video clips; audio capture of an audio stream generated by the one or more video clips; detect and/or monitor and/or record one or more game parameters one or more of before, during or after frame capture; and, generate content based on the captured game frames and the one or more game parameters.

In yet another aspect, the selected portion of a video game sent to the one or more gamer computers comprises video or video/audio clips corresponding to the one or more of the gamers' virtual in-game location or game state. The selected portions include one or more of game tips or recommendations for play. The recommendations for play derive from one or more of: player attributes, gamer level, game state, and virtual in-game position of the gamer. The recommendations for play comprise a plurality of different video or video/audio clips corresponding to a plurality of different recommendations for the one or more gamers to choose from.

In a further aspect, a method of for improving the playing of video gaming sessions includes: providing one or more gamer computer systems for use by one or more associated gamers; providing one or more servers, the one or more servers having an associated storage for storing one or more video or audio/video clips and associated metadata corresponding to one or more portions of a video game, the one or more servers are enabled to receive one or more requests from the one or gamers of the one or more gamer computers for a selected portion of a video game; further comprising sending one or more requests for one or more portions of a video game from the one or more gamer computer systems, the server searching, using the associated metadata, the associated storage to determine whether the selected portion is available, and, if available, transmitting the selected portion of the video game to the one or more gamer computer systems.

In a further aspect, the method includes providing one or more gameplay publisher computer systems, the one or more gameplay publisher computer systems sending the one or more video or audio/video clips and associated metadata extracted from the one or more video or audio/video clips to the associated storage of the one or more servers for storage. Further, the server indexes the stored video clips based, at least in part, on the associated metadata extracted from the one or more video or video/audio clips.

In yet a further aspect, the one or more gameplay publisher computer systems perform one or more of: frame capture of graphics frames generated by the one or more video clips; audio capture of an audio stream generated by the one or more video clips; detect and/or monitor and/or record one or more game parameters one or more of before, during or after frame capture; and, generate content based on the captured game frames and the one or more game parameters. The selected portion of a video game sent to the one or more gamer computers comprises video or video/audio clips corresponding to the one or more of the gamers' virtual in-game location or game state. The selected portions include one or more of game tips or recommendations for play. The recommendations for play derive from one or more of: player attributes, gamer level, game state, and virtual in-game position of the gamer.

In another aspect, the recommendations for play comprise a plurality of different video or video/audio clips corresponding to a plurality of different recommendations for the one or more gamers to choose from.

In a further aspect, the game play publisher computer systems are configured to detect the failure by the one or more gamers to succeed at one or more positions during a game a specified number of times and to recommend to the one or more gamers one or more video or video/audio clips tutorials corresponding to the one or more positions. The specified number of times may be greater than 1.

In yet another aspect, the one or more gamer computer systems are configured to request from the one or more servers notification of the presence of one or more secrets at one or more positions during a game. Upon notification of the presence of a secret, the one or more gamers are enabled to request the one or more secrets.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an example of a network level diagram of a video game content publishing, recommendation, and consumption system according to embodiments;

FIG. 2 is another example of a network level diagram of a video game content publishing and consumption system according to embodiments;

FIG. 3 is another example network level diagram of a video game content publishing and consumption system according to embodiments;

FIG. 4 shows an example of a clip search window in a game support module;

FIG. 5 shows a block diagram of an exemplary game publisher/game support module, and its functional modules;

FIG. 6 shows a block diagram of an exemplary split game publisher/game support module, and the functional modules on the player side;

FIG. 7 shows a block diagram of an exemplary split game publisher/game support module, and the functional modules on the server side; and

FIG. 8 shows a block diagram of an exemplary parameter detection module running on a remote server.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including magnetic hard disks, solid state disks (SSD), floppy disks, optical disks, CD-ROMs, DVDs, Blu-ray disks, magnetic-optical disks, read-only memories (ROMs), random access memories (RAMs) electrically programmable read-only memories (EPROMs), electrically erasable and programmable read only memories (EEPROMs), Flash memories, magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The popularity of video and computer gaming has created a lot of content on the internet related to video games. Gamers are publishing and using this content to share their experience and find assistance to overcome difficult parts of a game, or simply just to discuss different issues of a game, for instance, a gamer can brag on some extraordinary achievement in a game. Examples of such content are YouTube videos of a game, twitch TV live streaming, and webpages with written walkthroughs and guides. The problem with using these methods is that it consumes a lot of time finding the specific location in the game, in any of the abovementioned guides. Sometimes gamers simply watch the full walkthrough in parallel with the game, which requires them to constantly switch between them, and forces them to follow a specific game path. Other online gaming aids are gamer communities which discuss various gaming issues in general, and specific game issues in particular. Some of the discussions in the community forums may relate to the techniques for achieving a game goal in a specific level of a specific game. The problem with these discussions is that the members discussing the problem are diversified in many aspects, the gamers may not be of the same type, and even same type gamers may have different skills. In addition, it is most likely that each party participating in the discussion will get to a certain stage of a game in a different situation, for instance, one might get to a point in the game with more ammunition left than another gamer, or with more time left, or any other game parameter which may make the discussion among the gamers almost useless since each gamer has his own personal experience which may not necessarily be relevant to advancing the play of other gamers playing the same game. In addition, each gamer participating in the discussion may be interested in different things, for instance, one might be interested in secrets and another may be interested in moving to the next game stage. Therefore, there is a need to match a first gamer (tutorial publisher) with a certain set of parameters, for instance, which passed a certain stage of a game with given conditions (e.g. amount of ammunition left, types of ammunition used, number of enemy weapons destroyed, etc.), with a second gamer (content consumer) who seeks advice from a gamer who substantially has those set of parameters, for instance, from a gamer who reached the same stage with substantially similar conditions as those of the first gamer, and who can demonstrate how to cross that stage.

The term “tutorial” in the present invention is used just for convenience, but includes any game sequence whether for tutorial purposes or for any other purpose such as for bragging, sharing, and demonstration. In the present invention, any published game clip is referred to as tutorial regardless of the purpose it was published for. A “tutorial publisher” refers to any gamer publishing a game sequence, whether for teaching purposes or otherwise.

According to some embodiments of the present invention there is provided (1) gameplay publisher application which may analyze and collect metadata from a video and/or audio stream of a video game played by a tutorial publisher and upload content including the video/audio of the played game and the metadata to a remote server; (2) gameplay support module application which may analyze and collect metadata from a video and/or audio stream of a video game played by a content consumer and optionally upload at least part of the metadata to a remote recommendation engine and/or optionally search for uploaded content in the remote server; (3) optional recommendation engine which may receive, index, and store in a remote server the gameplay video and associated metadata uploaded by the gameplay publisher application, optionally receive some metadata from the gameplay support module, and match metadata uploaded by the gameplay publisher with metadata uploaded by the gameplay support module and send suggestions of recommended video clips to the gameplay support module; and (4) remote server for storing content uploaded by the gameplay publisher.

According to some other embodiments of the present invention, the gameplay publisher application may upload to the remote server just the audio/video stream, and the recommendation engine may analyze and collect metadata from the uploaded video and/or audio stream. According to some other embodiments of the present invention, the recommendation engine may receive, index, and store in a database in the remote server the gameplay video uploaded by the gameplay publisher and associated metadata uploaded by the gameplay publisher or extracted by the recommendation engine, and the gameplay support module may search the database for appropriate video clips according to the metadata stored in the database and associated with those clips.

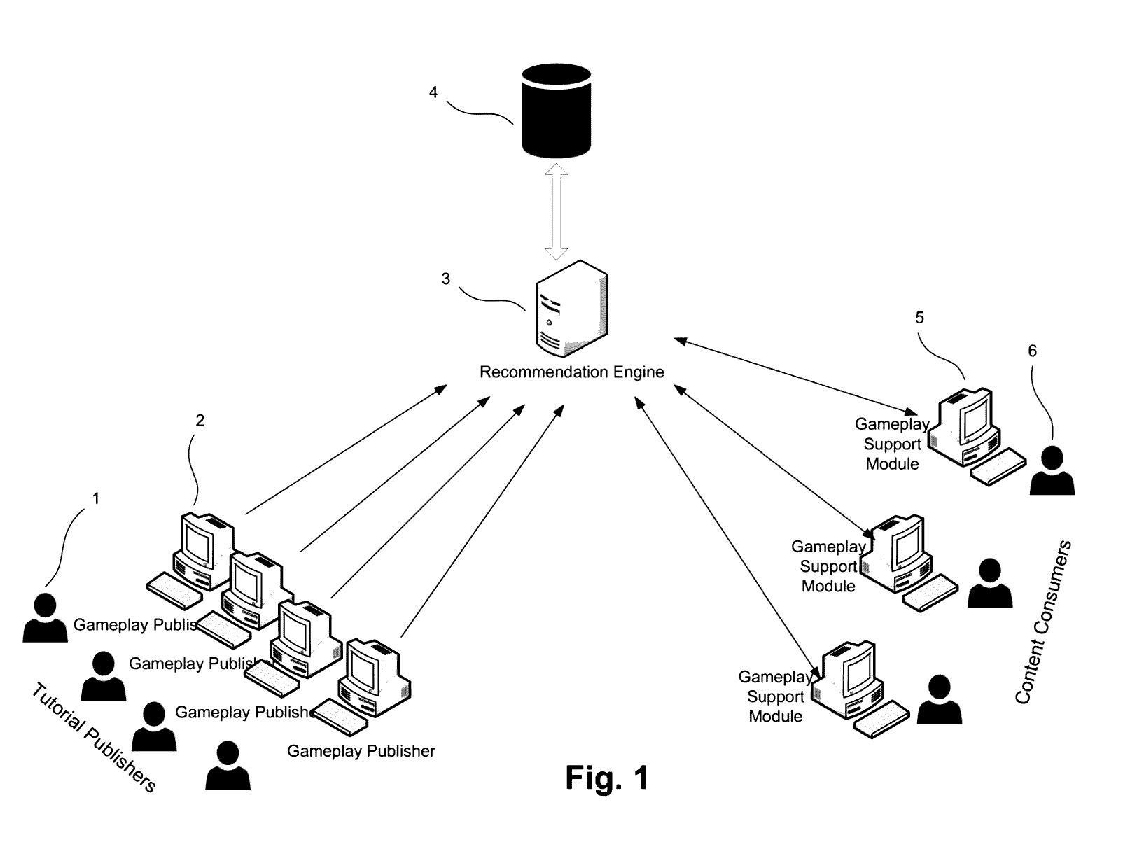

FIG. 1 shows an example of a system according to embodiments of the present invention. According to this example there are tutorial publishers (1) playing video games on computing platforms (2) on which a gameplay publisher application is also running. The gameplay publisher extracts metadata from the audio/video stream and uploads content which includes the audio/video and associated metadata to a remote server (3) which stores the audio/video stream in storage database (4). The server (3) also runs a recommendation engine application which receives game metadata and/or requests from gameplay support modules running on computing platforms (5) on which games played by content consumers (6) are running, and sends back to the gameplay support module information about suggested video clips that match the metadata and/or requests sent by the gameplay support module.

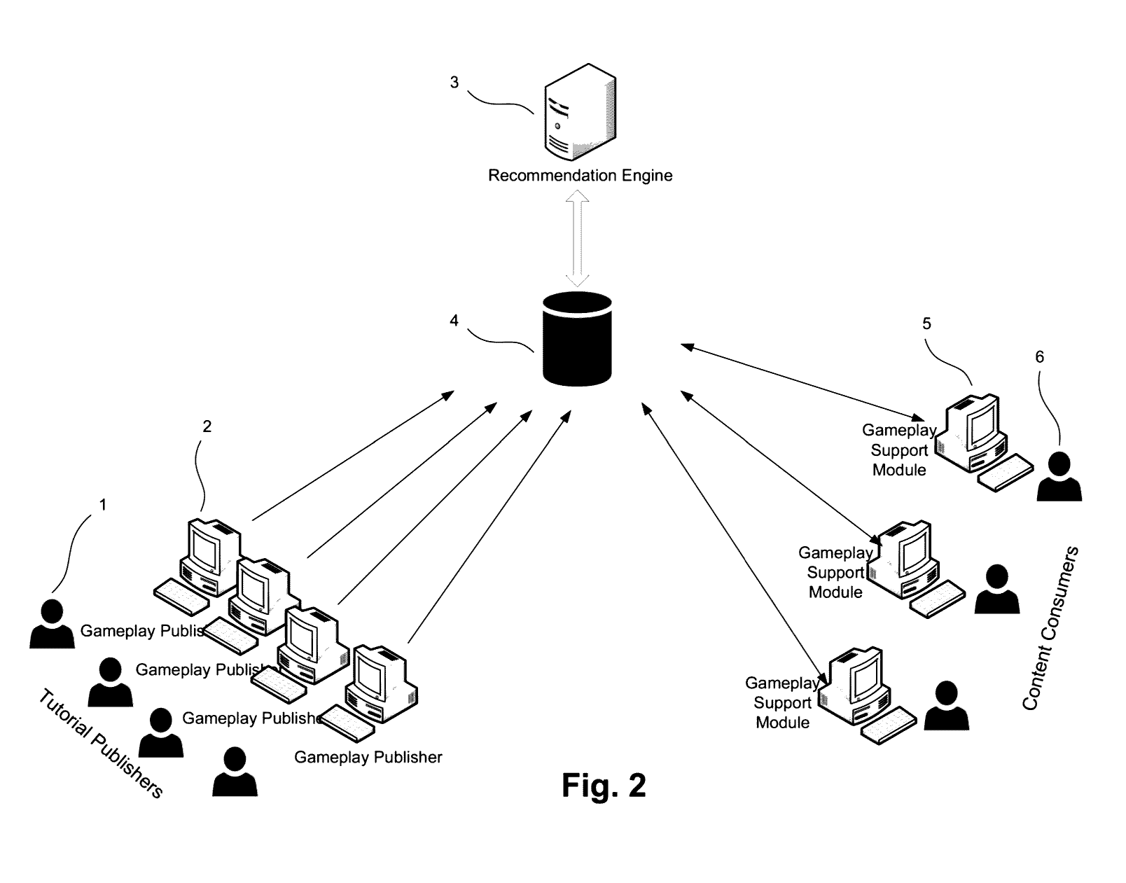

FIG. 2 shows another example of a system according to embodiments of the present invention. According to this example there are tutorial publishers (1) playing video games on computing platforms (2) on which a gameplay publisher application is also running. The gameplay publisher optionally extracts metadata from the audio/video stream and uploads the audio/video and associated optional metadata to a remote database (4). The server (3) runs a recommendation engine application which optionally extracts metadata from the uploaded audio/video stream and indexes the game metadata which was either uploaded by the gameplay publisher or extracted by the recommendation engine. Gameplay support modules running on computing platforms (5) on which games played by content consumers (6) are running, search the database (4) for relevant tutorial clips based on the metadata stored in the database.

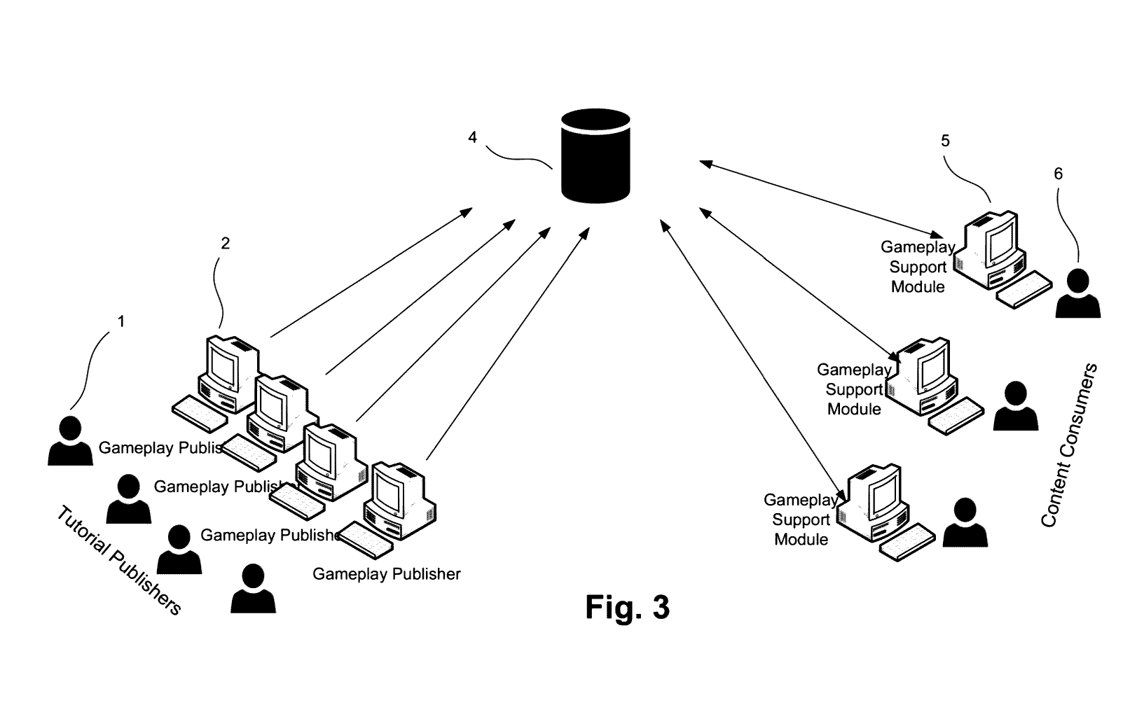

FIG. 3 shows another example of a system according to embodiments of the present invention. According to this example there are tutorial publishers (1) playing video games on computing platforms (2) on which a gameplay publisher application is also running. The gameplay publisher extracts metadata from the audio/video stream and uploads the audio/video and associated metadata to a remote database (4). Gameplay support modules running on computing platforms (5) on which games played by content consumers (6) are running, search the database (4) for relevant tutorial clips based on the metadata stored in the database.

According to some embodiments of the present invention, a gamer who wishes to publish a tutorial or some other demonstration of a gameplay (tutorial publisher), may play the game while having a gameplay publisher application running on the same or functionally associated computing platform and collecting information of the played game. According to some embodiments of the present invention, a gameplay publisher may include computer executable code for: (1) frame capture of graphics frames rendered by a video game running on the same or functionally associated computing platform during gameplay; (2) optionally audio capture of an audio stream generated by the video game; (3) detect, monitor and/or record one or more game parameters before, during and/or after the frame capture; (4) generate content based on the captured game frames and one or more game parameters; and (5) publish the generated content, optionally to a remote server, for viewing by other game players. According to some embodiments of the present invention, the gameplay publisher may be an application discrete from the video game code. According to embodiments, the gameplay publisher may access Application Interfaces (API's) of the video game. According to embodiments, the video game may access Application Interfaces (API's) of the gameplay publisher. According to yet further embodiments, the gameplay publisher code may be at least partially interwoven with the code of the video game. According to even further embodiments, the gameplay publisher code may be integrated into or with a gaming platform such as for example, “Steam”.

According to some embodiments of the present invention, the gameplay publisher may capture the graphics frames rendered by a video game by capturing the displayed video stream. According to other embodiments of the present invention, the gameplay publisher may capture the graphics frames rendered by a video game by capturing the commands sent to the graphics card. In this mode the captured file may be a lot more compact and the original video stream can be reproduced by simply running the captured set of commands through the graphics card. According to further embodiments, the remote server may have stored game resource files of the played game (e.g. texture files, object geometry files) and the gameplay publisher may upload to the remote server just signatures of the files being used, in this manner the amount of uploaded data is minimized. According to other embodiments, the gameplay publisher may upload a game resource file once, and thereafter upload only signatures of resource files that were previously uploaded, the remote server may cache the game resource files uploaded by the gameplay publisher (e.g. texture files, object geometry files) and then use the received signatures to retrieve the cached files, in this manner the amount of uploaded data is minimized.

According to some embodiments of the present invention, the gameplay publisher may capture the graphics frames rendered by a video game, and optionally also capture the audio stream of the game, and detect, monitor and/or record one or more game parameters, and/or generate content based on the captured game frames and/or audio stream and one or more game parameters and publish the generated content, optionally to a remote server. According to some other embodiments of the present invention, the gameplay publisher may capture the graphics frames rendered by a video game and optionally also capture the audio stream of the game, and publish it to a remote server. The remote server may detect, monitor and/or record one or more game parameters, and/or generate content based on the captured game frames and/or audio stream and one or more game parameters.

According to embodiments of the present invention, the functionality of the gameplay publisher may be done on a single platform, or may be split among several computing platforms. For instance, the frame capture, audio capture, game parameter detection, and generated content, may be done on the same computing platform the video game is played on. In other examples in which the gameplay publisher functionality is split, the frame and audio capture may be done on the same computing platform the video game is played on, and the game parameter detection, and generated content, may be done on a remote server.

According to some other embodiments of the present invention, the game parameters may be extracted from a game video stream and optionally also from the audio stream by a remote server. According to these embodiments, the remote server may detect game parameters in the game's audio/video stream and append the detected parameters as metadata to the game audio/video stream. For example, game parameters may be detected in any game tutorial published on YouTube.

According to some embodiments of the present invention, the gameplay publisher may continuously or according to certain conditions, capture the graphics frames rendered by a video game during gameplay. For example, a tutorial publisher may wish to capture and publish the entire gameplay, or he may wish to capture and publish only side quest portions of the gameplay.

According to some embodiments of the present invention, there may be provided, on a computing platform, a gameplay support module which may include computer executable code for: (1) detecting one or more game parameters of a game being played on the same or functionally associated computing platform; (2) optionally search an online database for content corresponding to the one or more detected game parameters; (3) list for user selection online content corresponding to the one or more parameters; and (4) play selected contented content relating to the one or more detected game parameters. The gameplay support module may be an application discrete from the video game code. According to embodiments, the gameplay support module may access Application Interfaces (API's) of the video game. According to embodiments, the video game may access Application Interfaces (API's) of the gameplay publisher. According to yet further embodiments, the gameplay support module code may be at least partially interwoven with the code of the video game. According to even further embodiments, the gameplay support module code may be integrated into or with a gaming platform such as for example, “Steam”.

According to some embodiments of the present invention, the gameplay publisher and/or the gameplay support module may detect in the video game and/or in the audio stream one or more game parameters. The game parameters may comprise: A game identifier such as the game name; the game version; the level played within the game; the progress within the level; the time it took the player to make that progress in the game; position of the player; the direction the player is looking at; number of failures in the level; character type such as magician, warrior, alien, etc.; player resources such as weapons, ammunition, strength, life, mana, Inventory, energy, abilities, money; Active resources such as weapons, armor, shield, rings; Commands given to the player; and statistics relating to player performance.

According to some embodiments of the present invention, the gameplay publisher and/or the gameplay support module may detect the one or more game parameters by watching the matrices passing through the graphics pipeline and analyzing these matrices to extract information such as the virtual camera location and/or orientation, different objects location, etc. According to some embodiments of the present invention, the gameplay publisher and/or the gameplay support module may detect the one or more game parameters by watching areas in the system memory and extracting information such as the player attributes (e.g. location, orientation, class, dressing, character type, etc.), game level, remaining ammunition, etc. According to some embodiments of the present invention, the gameplay publisher and/or the gameplay support module may detect the one or more game parameters by performing image processing of the displayed image, for instance, by using Optical Character Recognition (OCR) techniques to identify text displayed on the screen indicating certain game parameters (e.g. position/level—“Level 1”, “XYZ Castle”, “ABC Room”, “123 Command”). According to some embodiments of the present invention, the gameplay publisher and/or the gameplay support module may detect the one or more game parameters by performing image processing of the displayed image and correlating it with a database of known scenes from the game, for example, it may match the displayed image with a stored image in a database, or it may correlate a histogram of a displayed scene with a stored histogram in the database. According to some embodiments of the present invention, the gameplay publisher and/or the gameplay support module may detect the one or more game parameters by performing audio processing. The audio processing can be done on speech and/or on soundtrack and/or on sound effects. According to some embodiments the gameplay publisher and/or the gameplay support module may generate signatures of speech and/or soundtrack and/or sound effects during the game as identifiers of game events and/or location and/or game stage and/or game progress. According to some embodiments of the present invention, the gameplay publisher and/or the gameplay support module may detect the one or more game parameters by tracking the files that are being loaded into the audio card. The gameplay publisher and/or the gameplay support module may generate signatures of the loaded files as identifiers of game events and/or location and/or game stage and/or game progress. According to some embodiments of the present invention, the gameplay publisher and/or the gameplay support module may detect the one or more game parameters by analyzing the set of textures that are being used in a scene. According to some embodiments of the present invention, the gameplay publisher and/or the gameplay support module may detect the one or more game parameters by tracking the texture files that are being loaded. According to some embodiments of the present invention, the gameplay publisher and/or the gameplay support module may detect the one or more game parameters by analyzing the set of object geometries that are being used in a scene. According to some embodiments of the present invention, the gameplay publisher and/or the gameplay support module may detect the one or more game parameters by tracking the object geometry files that are being loaded. According to some embodiments of the present invention, the gameplay publisher and/or the gameplay support module may detect the one or more game parameters by analyzing the set of shaders that are being used in a scene. According to some embodiments of the present invention, the gameplay publisher and/or the gameplay support module may detect the one or more game parameters by tracking the shader files that are being loaded.

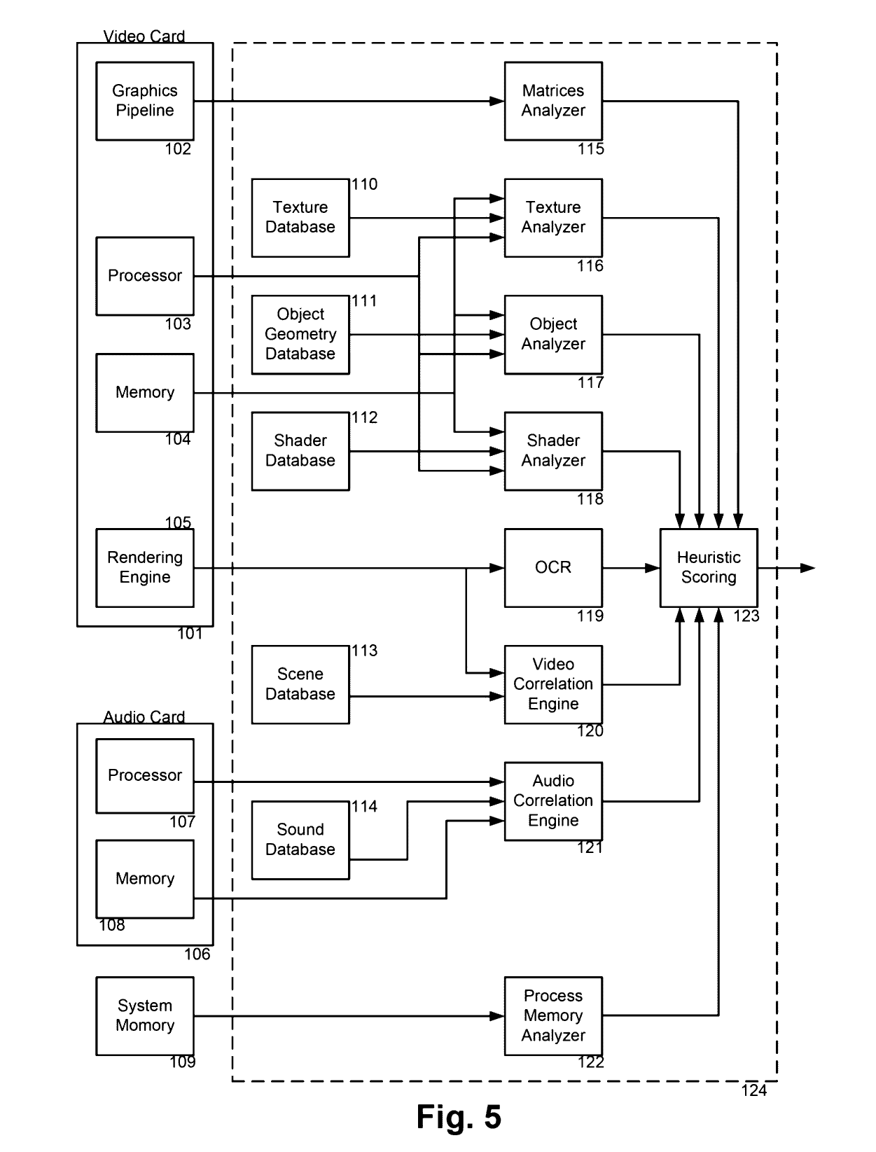

FIG. 5 is a functional block diagram of an exemplary gameplay publisher or gameplay support module, showing its functional modules. On the left side of the figure, the hardware of the computing platform on which the gameplay publisher or gameplay support module applications are running is depicted. The gameplay publisher or gameplay support module interface to the graphics card (101), the sound card (106), and the system memory (109). On the right side of the figure, the modules of the gameplay publisher or gameplay support module applications are depicted in the dashed line (124). At the start of a game the gameplay publisher or gameplay support module applications can identify the game, for instance by performing OCR using module (119) on the image rendered on the screen by the rendering engine (105). According to the identified game played, the gameplay publisher or gameplay support module applications can download from a remote server game related information such as a texture database (110), object geometry database (111), shader database (112), scene database (113), and sound database (114). The downloaded databases can then be used to correlate real-time play parameters with known game parameters. The texture analyzer module (116) receives texture information that is currently being used by the graphics processor (103) and correlates it with known textures from the texture database (110) to determine where in the game the player is playing. The texture analyzer (116) can in addition or alternatively correlate the textures that were loaded to the graphics card memory (104) with known textures in the texture database (110) in order to collect more information regarding where the play is. The object analyzer module (117) receives object geometry information that is currently being used by the graphics processor (103) and correlates it with known object geometries from the object geometry database (111) to determine where in the game the player is playing. The object analyzer (117) can in addition or alternatively correlate the object geometries that were loaded to the graphics card memory (104) with known object geometries in the object geometries database (111) in order to collect more information regarding where the play is. The shader analyzer module (118) receives shading information that is currently being used by the graphics processor (103) and correlates it with known shades from the shader database (112) to determine where in the game the player is playing. The shader analyzer (118) can in addition or alternatively correlate the shadings that were loaded to the graphics card memory (104) with known shaders in the shader database (112) in order to collect more information regarding where the play is. The audio correlation engine module (121) receives audio streams that are currently being played by the audio processor (107) and correlates it with known audio from the sound database (114) to determine where in the game the player is playing. The correlated sound can be anyone of, or a combination of soundtrack, sound effects, and/or speech. The audio correlation engine module (121) can in addition or alternatively correlate the sounds that were loaded to the audio card memory (108) with known soundtracks/sound-effects/speech in the sound database (114) in order to collect more information regarding where the play is. The video correlation engine module (120) receives video streams that are currently being rendered by the rendering engine (105) and correlates it with known images from the scene database (113) to determine where in the game the player is playing. The OCR module (119) detects alphanumeric characters rendered by the rendering engine (105) to extract various information such as where in the game the player is playing, commands, arsenal, strength, etc. The matrices analyzer (115) constantly examines the graphics pipeline (102) to determine 3D information such as the camera's position and orientation as well as the location and orientation of other objects within the 3D image. The process memory analyzer (122) extracts information from the system memory (109) such as the player location, dressing, class, properties, ammunition, game level, etc. The information collected by each of the different modules is usually not unique to a certain place in the game, for instance, the same soundtrack can be played along a long time during a campaign, or the same sound effects can be played in many different places in the game, or the same set of textures may be used in different places in the game. Therefore, sometimes it may not be enough to rely on a single module for determining a game condition, such as where in the game the player is playing, or the player location etc. In order to come to a unique conclusion of the required game condition, a blend of the data collected from several resources, such as from the video correlation engine, the audio correlation engine, the texture analyzer, the object analyzer, and the OCR module, may be used by a heuristic scoring algorithm performed in heuristic module (123). In this example of FIG. 5, the conclusion of the heuristic module (123) is saved by the gameplay publisher as a game parameter in the metadata file associated with the video capture. In the exemplary case of a gameplay support module, the conclusion of the heuristic module (123) can be used to search a remote server for tutorials matching the present game conditions, or, the conclusion of the heuristic module (123) can be sent to a remote recommendation engine which searches a database for a matching tutorial. The recommendation engine then suggests to the gameplay support module a list of matching tutorials from which the content consumer can select the one he wishes to watch.

According to some embodiments of the present invention, the gameplay support module may constantly search a database on a remote server for tutorials that match the current game conditions, or may constantly send information regarding the current game conditions to a remote recommendation engine which may search the database for matching tutorials. According to these embodiments, when a tutorial relevant to the current game conditions is found, it may be suggested to the content consumer which may decide to watch it or not. According to some embodiments of the present invention, the gameplay support module may initiate a tutorial search only upon a content consumer's request, (e.g. when the content consumer failed a challenge several times and requires assistance in the game). According to some embodiments of the present invention, the gameplay support module may provide the content consumer an option to set various filters according to which tutorials will be searched and suggested. For example, the content consumer may request the gameplay support module to search only for secrets when the content consumer is about to leave a scene which includes the secret and which the content consumer did not reveal.

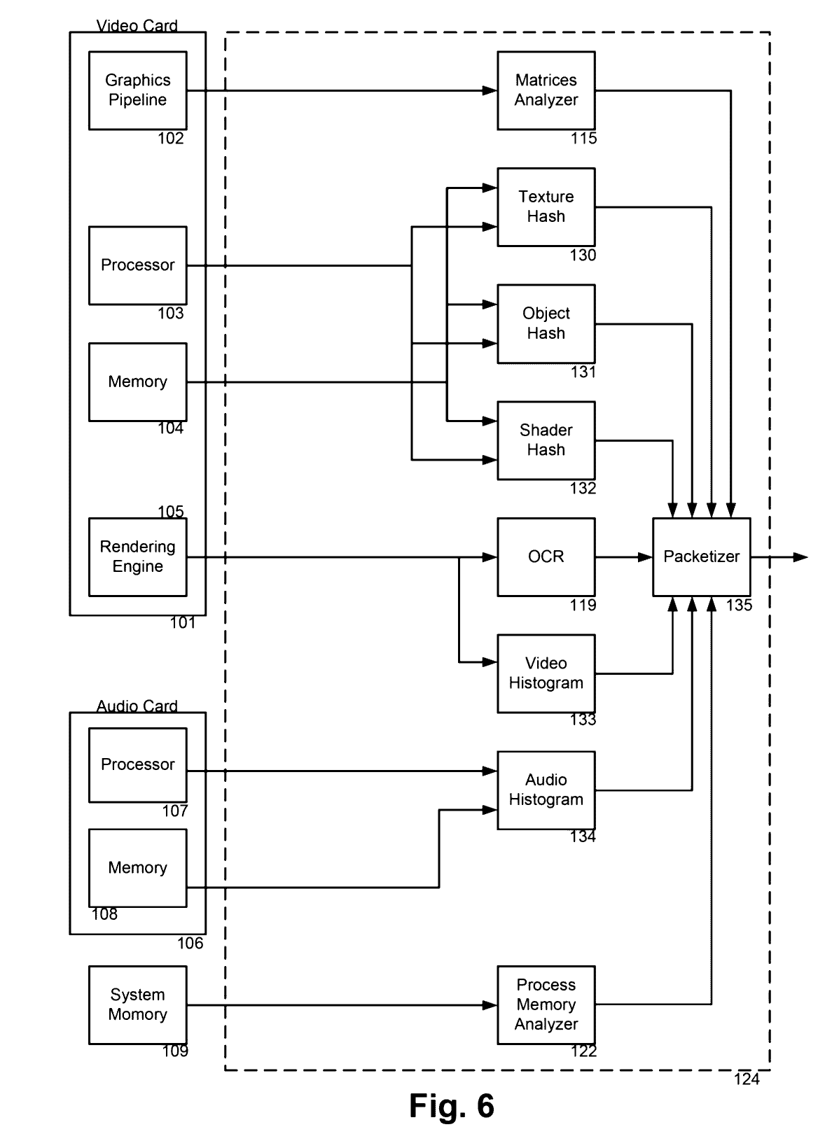

FIGS. 6 & 7 show an example in which the game parameter extraction is split between the gameplay publisher or gameplay support module, and a remote server. In this example the game database which includes textures, object geometries, shaders, game scenes, soundtracks, sound effects, and speeches, is not downloaded to the gameplay publisher or to the gameplay support module, and the analysis and correlation is done in the remote server.

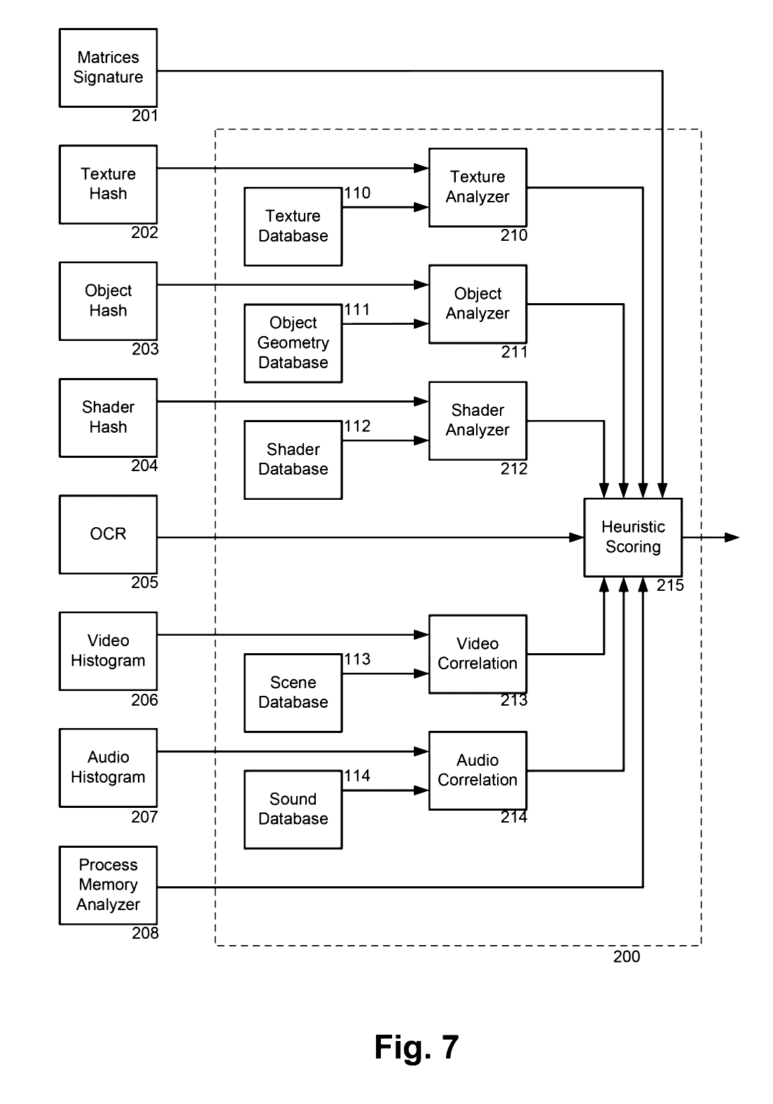

FIG. 6 is a functional block diagram of another exemplary gameplay publisher or gameplay support module, showing its functional modules. On the left side of the figure, the hardware of the computing platform on which the gameplay publisher or gameplay support module applications are running is depicted. The gameplay publisher or gameplay support module interface to the graphics card (101), the sound card (106), and the system memory (109). On the right side of the figure, the modules of the gameplay publisher or gameplay support module applications are depicted in the dashed line (124). The texture hash module (130) receives texture information that is currently being used by the graphics processor (103) and generates a hash signature representing the set of textures currently used. The texture hash module (130) can in addition or alternatively generate hash signatures of the textures that were loaded to the graphics card memory (104). The object hash module (118) receives object geometry information of objects that are currently being used by the graphics processor (103) and generates a hash signature representing the set of objects currently used. The object hash module (118) can in addition or alternatively generate hash signatures of the object geometries that were loaded to the graphics card memory (104). The shader hash module (132) receives shading information that is currently being used by the graphics processor (103) and generates a hash signature representing the set of shaders currently used. The shader hash module (132) can in addition or alternatively generate hash signatures of the shaders that were loaded to the graphics card memory (104). The audio histogram module (134) receives audio streams that are currently being played by the audio processor (107) and generates a signature of the audio stream, for instance by creating a histogram of the audio stream. The signature can be generated for anyone of, or a combination of soundtrack, sound-effects, and/or speech. The audio histogram module (134) can in addition or alternatively generate signatures for sound files that were loaded to the audio card memory (108). The video histogram module (133) receives video streams that are currently being rendered by the rendering engine (105) and generates signatures of the rendered video frames, for instance, by calculating a histogram of the frame. The OCR module (119) detects alphanumeric characters rendered by the rendering engine (105) to extract various information such as where in the game the player is playing, commands, arsenal, strength, etc. The matrices analyzer (115) constantly examines the graphics pipeline (102) to determine 3D information such as the camera's position and orientation as well as the location and orientation of other objects within the 3D image. The process memory analyzer (122) extracts information from the system memory (109) such as the player location, dressing, class, properties, ammunition, game level, etc. In this example, the signatures and parameters from the matrices analyzer module (115), texture hash module (130), object hash module (131), shader hash module (132), OCR module (119), video histogram module (133), audio histogram module (134), and process memory analyzer module (122) are all packetized together and sent to a remote server. In the case that the application sending the signatures is a gameplay publisher, the remote server may save the signatures as metadata along with the audio/video stream, or it may take a further step which will be explained in FIG. 7. In the case that the application sending the signatures is a gameplay support module, the remote server will analyze the signatures to find a matching tutorial as explained in the next figure.

FIG. 7 is a functional block diagram showing the functional modules of an application running on a remote server. The input to the application is shown on the left side of the figure and includes information sent by the gameplay publisher or gameplay support module. This information includes the matrices signatures (201), texture hash signatures (202), object hash signatures (203), shader hash signatures (204), OCR data (205), video signatures (206), audio signatures (207), and parameters extracted from the game processes memory (208). On the right side of the figure, the functional modules of the application are shown in a dashed line rectangular (200).

The application (200) includes game databases which can be used to correlate real-time play parameters with known game parameters. The texture analyzer module (210) receives texture signatures from block (202) of textures that are currently being used and correlates them with known texture signatures from the texture database (110) to determine where in the game the player is playing. The texture analyzer (210) can in addition or alternatively correlate the signatures of textures that were loaded to the graphics card memory with known texture signatures in the texture database (110) in order to collect more information regarding where the play is. The object analyzer module (211) receives object geometry signatures from block (203) of objects that are currently being used and correlates it with known object geometry signatures from the object geometry database (111) to determine where in the game the player is playing. The object analyzer (211) can in addition or alternatively correlate the signatures of object geometries that were loaded to the graphics card memory with known object geometry signatures in the object geometries database (111) in order to collect more information regarding where the play is. The shader analyzer module (212) receives shading signatures from block (204) of shaders that are currently being used and correlates it with known shade signatures from the shader database (112) to determine where in the game the player is playing. The shader analyzer (212) can in addition or alternatively correlate the signatures of shadings that were loaded to the graphics card memory with known shader signatures in the shader database (112) in order to collect more information regarding where the play is. The audio correlation engine module (214) receives from block (207) signatures of audio streams that are currently being played by the audio processor and correlates it with known audio signatures from the sound database (114) to determine where in the game the player is playing. The signatures of the correlated sound can be anyone of, or a combination of soundtrack signatures, sound effects signatures, and/or speech signatures. The audio correlation engine module (214) can in addition or alternatively correlate the signatures of sounds that were loaded to the audio card memory with known signatures of soundtracks/sound effects/speech in the sound database (114) in order to collect more information regarding where the play is. The video correlation engine module (213) receives from block (206) signatures of video streams that are currently being rendered by the rendering engine and correlates it with signatures of known images from the scene database (113) to determine where in the game the player is playing. OCR information such as where in the game the player is playing, commands, arsenal, strength, etc. is received from the gameplay publisher or gameplay support module from block (205). Signatures of 3D information extracted from the graphics pipeline matrices, such as the camera's position and orientation as well as the location and orientation of other objects within the 3D image, are received from the gameplay publisher or gameplay support module from block (201). Information such as the player location, dressing, class, properties, ammunition, game level, etc., extracted from the game's process memory by the gameplay publisher or gameplay support module process memory analyzer, is received from block (208). The different information received is usually not unique to a certain place in the game, for instance, the same soundtrack signatures can appear along a long time during a campaign, or the same sound effect signatures can appear in many different places in the game, or the same set of texture signatures may appear in different places in the game. Therefore, sometimes it may not be enough to rely on a single signature source for determining a game condition, such as where in the game the player is playing, or the player location etc. In order to come to a unique conclusion of the required game condition, a blend of the data collected from several resources, such as video signatures, audio signatures, texture signatures, object geometry signatures, and OCR data, may be used by a heuristic scoring algorithm performed in heuristic module (215). In this example of FIG. 7, the conclusion of the heuristic module (215) is saved by the remote application as a game parameter in the metadata file associated with the video capture uploaded by the gameplay publisher. In the exemplary case in which the signatures are received from a gameplay support module, the conclusion of the heuristic module (215) can be used by a recommendation engine which searches a database for a matching tutorial. The recommendation engine then suggests to the gameplay support module a list of matching tutorials from which the content consumer can select the one he wishes to watch.

According to some embodiments of the present invention, the gameplay publisher may upload the audio/video stream of the play to a database on a remote server, and an application running on the remote server or on a platform associated with the remote server may detect the one or more game parameters.

According to some embodiments of the present invention, signatures representing the analyzed audio/video (e.g. shaders) may be generated as game parameters. For instance, the signatures may be a result of some hashing function performed on the audio/video (e.g. speech, soundtrack, textures, etc.) In other cases the game parameter may be a result of the analysis of the audio/video, for instance, by analyzing the matrices passing through the graphics pipeline the virtual camera location and/or orientation may be extracted, or by performing OCR on the displayed image, the game level and/or progress/location within the level can be extracted. In other cases the signature may be a result of the analysis of the audio/video, for example, a signature of an object can be defined according to its object geometry parameters such as its primitive count, vertices count, indices count, or any combination, or a hash of any combination of the above.

According to some embodiments of the present invention, the gameplay publisher may constantly save the detected one or more game parameters and/or generate and save signatures representing the analyzed audio/video. According to other embodiments of the present invention, the gameplay publisher may upload the gameplay video and optionally also audio to a remote server, and an application running on the remote server or on a platform functionally associated with the remote server may detect and save the one or more game parameters and/or generate and save signatures representing the analyzed audio/video.

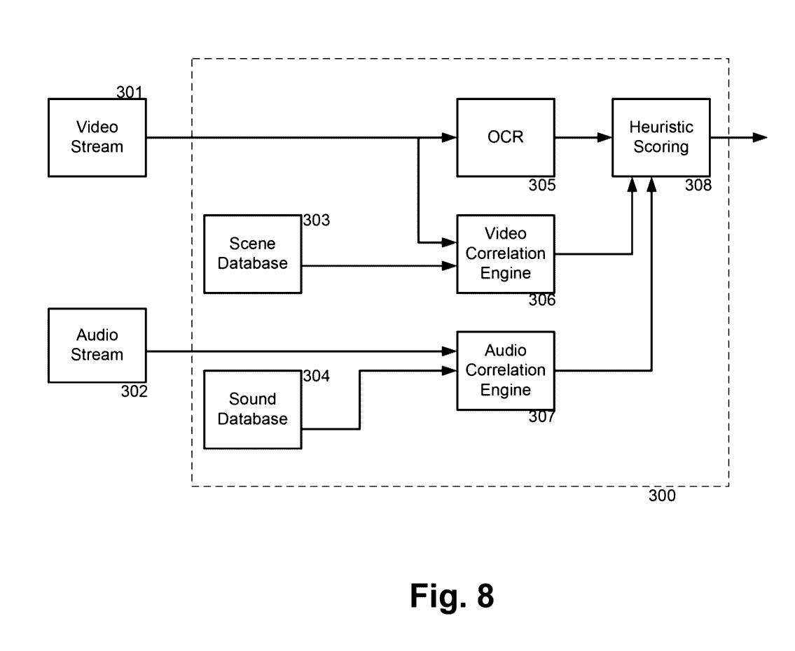

FIG. 8 shows an example according to embodiments in which the audio/video stream is uploaded by the gameplay publisher to a remote server and a game parameter extraction application running on the remote server or on a computing platform functionally associated with the remote server detects the game parameters. According to this example, the game parameter extraction application may detect game parameters also from game audio/video streams that were uploaded to the remote server by applications other than the gameplay publisher, for example, the game parameter extraction application may detect game parameters from game tutorial clips stored on YouTube. The game parameter extraction application (300) has an audio correlation module (307) which receives the audio stream (302) of the gameplay and correlates it to known streams of the game stored in a sound database (304). The video correlation module (306) receives the video stream (301) of the gameplay and correlates it to known scenes of the game stored in a scene database (303). The OCR module (305) receives the video frames from the video stream (301) and detects alphanumeric characters within the frames. The results of the video correlation, audio correlation, and OCR are fed into a heuristic scoring algorithm which concludes the game parameter and stores it as metadata along with the audio/video stream.

The tutorial publisher may add to the game content generated by the gameplay publisher or by a remote application, information associated with the play. For instance, the tutorial publisher may add a video clip showing some related information, or a snapshot of an important scene or of the character. The tutorial publisher gamer may play the game in different ways, the game may be played in the main story path without side quests or it may be played with side quests, or some parts of the game may be played in the main story path and other parts may be played with side quests, and/or the gamer may find secrets in the game, for instance he may hit a wall with his sword which may cause a secret door in the wall to open revealing some hidden ammunition behind the door, and/or the gamer may find an Easter Egg planted in the game if he presses some combination of keys while he is in a certain stage in the game, and/or the gamer may play the game in a very extraordinary way, for instance the gamer may kill 10 other players in a multiplayer game without being hit even once, or he may pass a very difficult stage with no ammunition, in these cases the gamer may wish to show-off his achievement. In all these cases the tutorial publisher may add information related to his play, for example, when the tutorial publisher discovers a secret he may add a ‘secret’ tag to the game content.

According to some embodiments of the present invention, the tutorial publisher may append some information to the content generated by the gameplay publisher or by a remote application. The appended information may include narration; captions; video clips, optionally with narration and/or captions; Image snapshots; video snapshots; Tags such as Secrets, Easter Egg, Spoiler, Main Story Path, Side Quest, Showoff/Brag, Player type (Novice, Intermediate, Hardcore); the tutorial publisher's name or nickname. The tags may be marked for a specific point/location in the game (e.g. a secret tag will be appended when a secret is discovered), or the entire game may be tagged, for instance, a game in which the tutorial publisher played only the main story path. The tutorial publisher may append this information while he is playing the game and/or after completing a game level and/or after finishing playing the game. According to some embodiments of the present invention, the gameplay publisher may include a user interface enabling the tutorial publisher to append information to the game content.

According to some embodiments of the present invention, other players (content consumers) may rate or vote for different game parameters, for instance the content consumers may rate the tutorial publisher's skills, or the content consumers may vote in favor/against or rate a gameplay tutorial, or the content consumers may vote in favor/against a tag the tutorial publisher appended. According to some embodiments of the present invention, the gameplay support module may include a user interface enabling the content consumer to vote. According to some embodiments of the present invention, the content consumer may vote by visiting a voting website.

According to some embodiments of the present invention, the gameplay publisher and/or the gameplay support module may extract certain information from the gameplay, for instance, the tutorial publisher's or the content consumer's skill or the difficulty of a certain scene/game level. For example, by determining the time it takes the gamer to progress within a level and/or by the number of times he failed/died in a certain location, the gameplay publisher and/or the gameplay support module may understand the level difficulty and/or the gamer's skill. A failure/death can be determined for instance, by an instant change of position/orientation, and/or by detecting a loading screen.

According to some embodiments of the present invention, the content generated by the gameplay publisher may include: (1) the graphics frames rendered by a video game; (2) audio stream generated by the video game; and metadata which includes: (3) game parameters associated with the video frames and/or audio stream; (4) general game parameters (e.g. Game name, Game version, Player level); (5) data appended by the tutorial publisher; and (6) data extracted by the gameplay publisher (e.g. difficulty).

According to some embodiments, there may be provided, on a computing platform, preferably on a server to which the content was uploaded to, or another computing platform functionally associated with that server, a recommendation engine which may include computer executable code for: (1) receiving content from one or multiple gameplay publishers; (2) sorting the content according to game; (3) collecting content consumers' rate and/or vote and adding the rating/vote statistics to the game metadata; (4) extracting information from multiple uploaded content of the same game and adding that information to the game metadata. For instance, a certain point in the game in which there are many failures of multiple players may be rated as difficult. A tutorial publisher's skill may be rated according to the number of failures compared to other players passing that level (5) indexing the gameplay metadata for easy and fast search and/or retrieval; (6) receiving content requests from content consumers and/or gameplay support modules, and providing them the required content; and (7) receiving game and player parameters from gameplay support modules, and sending information regarding suggested clips which may be relevant to the content consumer.

According to some embodiments of the present invention, the indexing may be done in several dimensions, for instance, on tags, position, orientation, level progress, game name, game version, game type, difficulty, tutorial publisher's name, votes.

According to some embodiments of the present invention, the recommendation engine may collect statistics of different parameters by observing the gameplay of multiple content consumers and tutorial publishers playing a certain game. The recommendation engine may index these parameters according to that statistics. For example, if most players discovered a certain secret during their play, the recommendation engine may come to the conclusion that this secret is simple to find and may automatically rate it as such and index it according to its simplicity/difficulty.

According to some embodiments of the present invention, the gameplay publisher and/or the gameplay support module and/or the recommendation engine may detect the game level the gamer is in, the location within the level, the stage the gamer is in, and other relevant information which substantially determines the location/situation the gamer is in, by combining information gathered from several resources and heuristically concluding the gamer's location/situation. The information may for instance be gathered from the video stream, the audio stream, loaded video files, loaded audio files, matrices passing through the graphics pipeline, examining memory areas inside the game process, OCR image processing, correlating displayed scene with stored scene in a database, correlating played sounds (speech, sound effects, soundtrack) with database of known sounds from the game, loaded/currently used textures, loaded/currently used object geometries, and loaded/currently used shaders. According to some embodiments of the present invention, while the content consumer is playing the game, the gameplay support module may search in the remote server which contains the support content uploaded by the tutorial publishers, for relevant advice related to the location/situation the content consumer is in. According to some other embodiments of the present invention, while the content consumer is playing the game, the gameplay support module may send the gamer's location/situation information to the recommendation engine. The recommendation engine may search the database for relevant advice related to the location/situation the content consumer is in. The search may be partially based on pairing a clip having a location/situation which substantially matches that of the heuristic conclusion of the content consumer's location/situation. According to some embodiments of the present invention, there may be other criteria for search such as the level of the tutorial publisher, and/or tags which match the content consumer's requirements, for instance, the content consumer may wish to get advice only on secrets, in that case the gameplay support module or recommendation engine may search only for clips which contain a ‘secret’ tag at that game location.

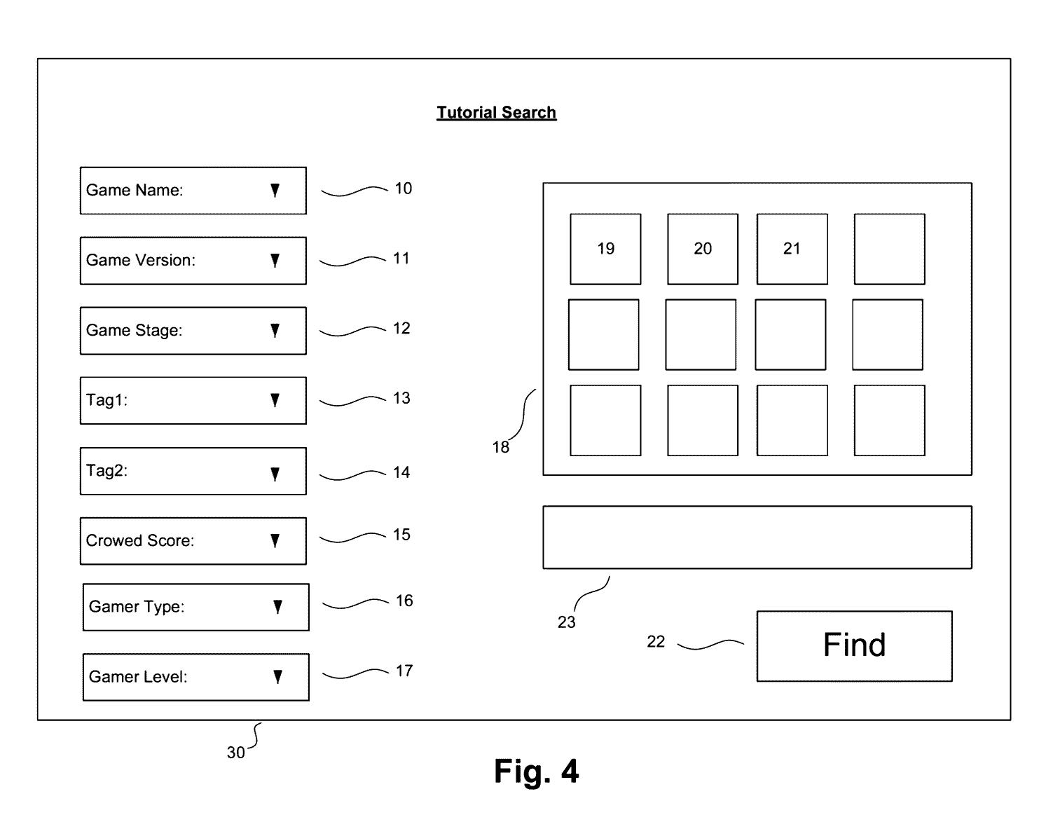

According to some embodiments of the present invention, the content consumer may search the database for tutorial clips he may be interested in. The content consumer may search the database while playing a game or not. The search may be done according to a set of rules the content consumer may set. For instance, the content consumer may wish to see a video clip of a game chosen from a list of games, at a certain level/stage of the game (e.g. 3), which was uploaded by a tutorial publisher of a certain type (e.g. hardcore). The content consumer may then receive from the recommendation engine a list of image snapshots of scenes from that level/stage of the game which were uploaded by tutorial publishers of the chosen type, and choose one of the clips to watch. The content consumer may choose to further narrow down the list by adding additional sorting criteria, for instance, he may sort only the clips that are in the main story path and further narrow the list by sorting out the clips in which there is the most ammunition left. According to some embodiments of the present invention, the content consumer may set content search criteria which will be suggested to him while he is playing the game. For instance, the content consumer may ask to get alerts only when he reaches a point in the game in which there are secrets, or the content consumer may be a beginner and ask to get alerts at any point in the game in which there is some published tutorial. According to this embodiment, when the content consumer reaches a point in the game that meets his search criteria, the gameplay support module may alert the content consumer that there is an available tutorial that matches his search criteria, the alert may be in the form of a popup that will appear on the screen (e.g. at the top right corner), the popup may be for example in the form of a textbox or an icon, or the alert can be audible, or both. Upon receiving an alert, the content consumer may click the popup or some keyboard key to view the tutorial, alternatively, if there are several tutorials that meet the search criteria, a search window such as shown for example in FIG. 4 may open to enable the content consumer choose the clip he is interested watching.

FIG. 4 shows an example of a tutorial video clip search screen 30. In this example the content consumer may select the game from a list of games in the dropdown menu 10, the game version from a list of versions that exist for the selected game from dropdown menu 11, the game stage from dropdown menu 12. The content consumer may then further select certain tags, such as a clip of a game played only in the main story path in dropdown menu 13, and further narrow down the search only with clips that discover secrets in dropdown menu 14, and even further narrow down the search only with clips that have a high score of other content consumers in the crowed score dropdown menu 15. The content consumer may then further more narrow that search by selecting the gamer type in dropdown menu 16, and even further more narrow down the search by selecting the tutorial publisher's level as it was analyzed by the recommendation engine relative to the level of other tutorial publishers in dropdown menu 17. When pressing the ‘Find’ button 22, the recommendation engine may present on the search window 30 in area 18 snapshots 19, 20, 21 of the relevant video clips according to the search criteria the content consumer set. The content consumer may then click on one of the icons 19, 20, 21 to see text in window 23 which the tutorial publisher appended to the tutorial clip. The content consumer may then browse the other icons 19, 20, 21 to see their appended text and then double click the desired icon to watch the selected tutorial clip.

According to some embodiments of the present invention, the uploaded content may be stored on a dedicated server. According to some other embodiments of the present invention, the uploaded content or part of it (e.g. video clip) may be stored on a third party service such as YouTube. According to this embodiment, metadata can optionally be stored on the third party service (e.g. YouTube) in a format provided by the third party service for other use. For example, in YouTube the metadata can be encoded into text and stored in the video description text field provided by YouTube.

According to some embodiments of the present invention, the gameplay support module may play the tutorial clip on the same platform the content consumer is playing the game on, or it may redirect the tutorial clip to be displayed on a different platform.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A system for improving the playing of video gaming sessions comprising:
one or more gamer computer systems and associated one or more gamers;
one or more servers, the one or more servers having an associated storage for storing one or more video or audio/video clips and associated metadata corresponding to one or more portions of a video game;
wherein the one or more servers are enabled to receive one or more requests from the one or more gamers of the one or more gamer computers for a selected portion of a video game;
wherein, upon receipt of one or more requests from the one or more gamer computer systems, the server searches, using the associated metadata, the associated storage to determine whether the selected portion is available, and, if available, transmits the selected portion of the video game to the one or more gamer computer systems.

2. The system of claim 1, further comprising one or more gameplay publisher computer systems, the one or more gameplay publisher computer systems being enabled to send the one or more video or audio/video clips and associated metadata extracted from the one or more video or audio/video clips or game parameters to the associated storage of the one or more servers for storage.

3. The system of claim 2, further comprising wherein the server indexes the stored video clips based, at least in part, on the associated metadata extracted from the one or more video or video/audio clips.

4. The system of claim 2, wherein the one or more gameplay publisher computer systems performs one or more of: frame capture of graphics frames generated by the one or more video clips; audio capture of an audio stream generated by the one or more video clips;
detect and/or monitor and/or record one or more game parameters one or more of before, during or after frame capture; and, generate content based on the captured game frames and the one or more game parameters.

5. The system of claim 1, wherein the selected portion of a video game sent to the one or more gamer computers comprises video or video/audio clips corresponding to the one or more of the gamers' virtual in-game location or game state.

6. The system of claim 5 wherein the selected portions includes one or more of game tips or recommendations for play.

7. The system of claim 6, wherein recommendations for play derive from one or more of: player attributes, gamer level, game state, and virtual in-game position of the gamer.

8. The system of claim 7, wherein the recommendations for play comprise a plurality of different video or video/audio clips corresponding to a plurality of different recommendations for the one or more gamers to choose from.

9. A method for improving the playing of video gaming sessions comprising:
providing one or more gamer computer systems for use by one or more associated gamers;
providing one or more servers, the one or more servers having an associated storage for storing one or more video or audio/video clips and associated metadata corresponding to one or more portions of a video game, the one or more servers are enabled to receive one or more requests from the one or gamers of the one or more gamer computers for a selected portion of a video game;
further comprising sending one or more requests for one or more portions of a video game from the one or more gamer computer systems, the server searching, using the associated metadata, the associated storage to determine whether the selected portion is available, and, if available, transmitting the selected portion of the video game to the one or more gamer computer systems.

10. The method of claim 9, further comprising providing one or more gameplay publisher computer systems, the one or more gameplay publisher computer systems sending the one or more video or audio/video clips and associated metadata extracted from the one or more video or audio/video clips or game parameters to the associated storage of the one or more servers for storage.

11. The method of claim 10, the server indexing the stored video clips based, at least in part, on the associated metadata extracted from one or more or the one or more video or video/audio clips or game parameters.

12. The method of claim 10, the one or more gameplay publisher computer systems performing one or more of: frame capture of graphics frames generated by the one or more video clips; audio capture of an audio stream generated by the one or more video clips;
detect and/or monitor and/or record one or more game parameters one or more of before, during or after frame capture; and, generate content based on the captured game frames and the one or more game parameters.

13. The method of claim 9 wherein the selected portion of a video game sent to the one or more gamer computers comprises video or video/audio clips corresponding to the one or more of the gamers' virtual in-game location or game state.

14. The method of claim 13 wherein the selected portions includes one or more of game tips or recommendations for play.

15. The method of claim 14, wherein the recommendations for play derive from one or more of: player attributes, gamer level, game state, and virtual in-game position of the gamer.

16. The method of claim 15, wherein the recommendations for play comprise a plurality of different video or video/audio clips corresponding to a plurality of different recommendations for the one or more gamers to choose from.

17. The method of claim 10, wherein the game play publisher computer systems are configured to detect the failure by the one or more gamers to succeed at one or more positions during a game a specified number of times and to recommend to the one or more gamers one or more video or video/audio clips tutorials corresponding to the one or more positions.

18. The method of claim 17 wherein the specified number of times is greater than 1.

19. The method of claim 10, wherein the one or more gamer computer systems are configured to request from the one or more servers notification of the presence of one or more secrets at one or more positions during a game.

20. The method of claim 19, wherein upon notification of the presence of a secret, the one or more gamers are enabled to request the one or more secrets.
